(19) United States
(12) Patent Application Publication
(10) Pub. No.: US 2019/0063492 A1
(43) Pub. Date: Feb. 28, 2019

(54) BEARING DEVICE

(71) Applicant: KAMOSEIKO KABUSHIKI KAISHA, Toyota-shi (JP)

(72) Inventors: Masashi OZAKI, Toyota-shi (JP); Kengo KISHI, Toyota-shi (JP)

(73) Assignee: KAMOSEIKO KABUSHIKI KAISHA, Toyota-shi (JP)

(21) Appl. No.: 16/054,488

(22) Filed: Aug. 3, 2018

(30) Foreign Application Priority Data
Aug. 25, 2017 (JP) 2017-161833
Jul. 10, 2018 (JP) 2018-130622

(51) Int. Cl. F16C 19/46; F16C 19/26; F16C 33/52; F16C 33/56; F16C 33/37

(52) U.S. Cl. CPC F16C 19/463; F16C 19/26; F16C 19/548; F16C 33/56; F16C 33/3706; F16C 33/52

(57) ABSTRACT

In a bearing device 1, a plurality of columnar needle rollers 13 are provided. A cage 14 is provided in which the needle rollers 13 are arranged in parallel with each other along an axial direction R of a pin roller 9, so that the needle rollers 13 form a cylindrical configuration around the pin roller 9. The cage 14 has oppositely placed two rings 17 and a plurality of bridge pieces 18 bridged between the two rings 17, and having the bridge pieces 18 to rotatably accommodate the needle rollers 13 in order to achieve higher performances.

### BACKGROUND OF THE INVENTION

### Field of the Invention

The present invention relates to a mechanically assembled bearing device.

In a rack-and-pinion type drive mechanism which has been applied to various kinds of machine tools and transfer machines, these mechanisms are disclosed by Japanese Laid-open Patent Application No. 2013-36488.

These mechanisms comprise a plurality of needle rollers and a cage which holds the needle rollers. By way of illustration, the needle rollers are represented by cylindrical columns made of metallic material.

The cage places the needle rollers in a cylindrical configuration, and arranges the needle rollers to axially align in parallel with each other. The cage has a cylindrical inner surface formed by the needle rollers to support an outer surface of a pin roller.

For this type of the bearing device, various good performances have been required to solve the problems from the points of low noise, least vibration, low transmissive resistance and acceptable rattling level with high rigidity.

### SUMMARY OF THE INVENTION

According to the present invention, there is provide a bearing device which supports rotatable and reciprocally movable component parts (component objects). The bearing device has a plurality of needle rollers and a cage which holds the needle rollers. The needle rollers are represented by cylindrical columns made of metallic material.

The cage places the needle rollers in a cylindrical configuration, and arranges the needle rollers to position in parallel with each other along an axial direction of the component parts. The cage has a cylindrical inner surface formed by the arranged needle rollers to support an outer surface of a pin roller.

The cage has two oppositely placed rings and a plurality of bridge pieces which connect between the two rings. Along the bridge pieces, a plurality of needle rollers are accommodated between the bridge pieces.

With the needle rollers accommodated between the bridge pieces, it is potentially possible for the bearing device to advantageously achieve enhanced performances in various ways.

### BRIEF DESCRIPTION OF THE DRAWINGS

A preferred form of the present invention are illustrated in the accompanying drawings in which:

FIG. 1 is a perspective view showing a drive device according to a first embodiment of the invention;

FIG. 2 is an exploded perspective view showing a pinion;

FIG. 3 is an exploded perspective view showing a bearing device together with a pin roller;

FIG. 4 is an exploded perspective view showing a cage and needle rollers;

FIG. 5 is a perspective view showing the cage which holds the needle rollers;

FIG. 6 is a longitudinal cross sectional view taken along the line V-V of FIG. 7;

FIG. 7 is a latitudinal cross sectional view taken along the line VI-VI of FIG. 6;

FIG. 8 is an enlarged cross sectional view surrounded by dash lines VII-VII of FIG. 7;

FIG. 9 is an enlarged cross sectional view showing a main portion of the bearing device according to a second embodiment of the invention; and

FIG. 10 is a perspective view showing a retainer interposed between neighboring ones of the needle rollers.

### DETAILED DESCRIPTION OF PREFERRED EMBODIMENTS

In the following description of the depicted embodiments to carry out the invention, described are a bearing device applied to a pin-roller type pinion device in which a support structure is improved upon supporting the pin rollers within a cage. In the following description of the depicted embodiments, the same reference numerals are used for features of the same type.

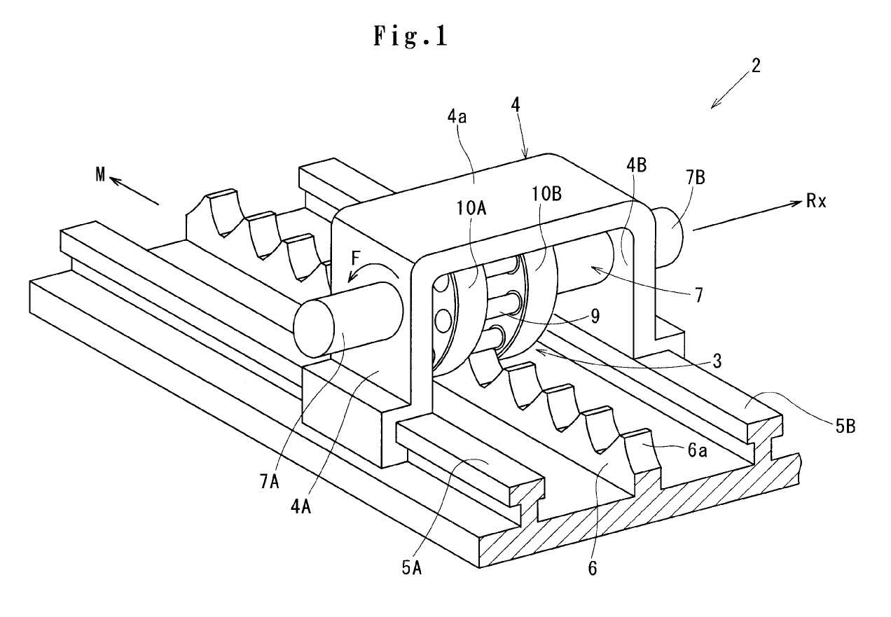

Referring to FIG. 1 which shows a bearing device 1 according to a first embodiment of the invention, the bearing device 1 is incorporated into a pinion 3 in a rack-and-pinion type drive device 2.

The rack-and-pinion type drive device 2 transfers various kinds of products by moving a housing 4 along two parallel rails 5A, 5B. A rack 6 is placed between the rails 5A, 5B, and a pinion 3 is accommodated into the housing 4. The pinion 3 has a rotational shaft 7, an axial direction Rx of which is perpendicular to a lengthwise direction M of the rack 6.

The housing 4 is formed into a gate-shaped configuration and having a ceiling 4a which lies above the pinion 3.

Outer walls 4A, 4B positioned to slidably fit into the rails 5A, 5B are provided with the housing 4. Each of the rails 5A, 5B is T-shaped in cross section, and the outer walls 4A, 4B are placed at a basal portion opposite to the ceiling 4a.

The rotational shaft 7 has one end 7A rotatably supported by the outer wall 4A, and having other end 7B rotatably supported by the outer wall 4B. The rotational shaft 7 is to be driven by an electric motor of conventional type (not shown).

The pinion 3 is to be rotated in a rotational direction F, while at the same time, engaging each of the pin rollers 9 with the teeth 6a of the rack 6 in turn to advance in the lengthwise direction M when the pinion 3 is subjected to a certain magnitude of torque. By way of example, the teeth 6a has a profile along a cycloidal curve.

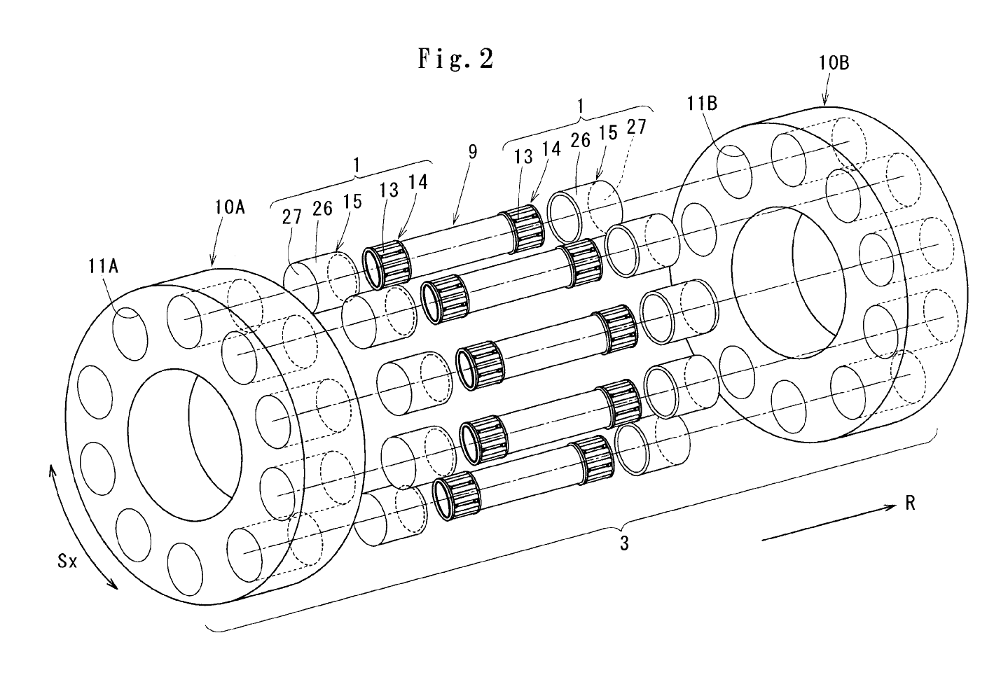

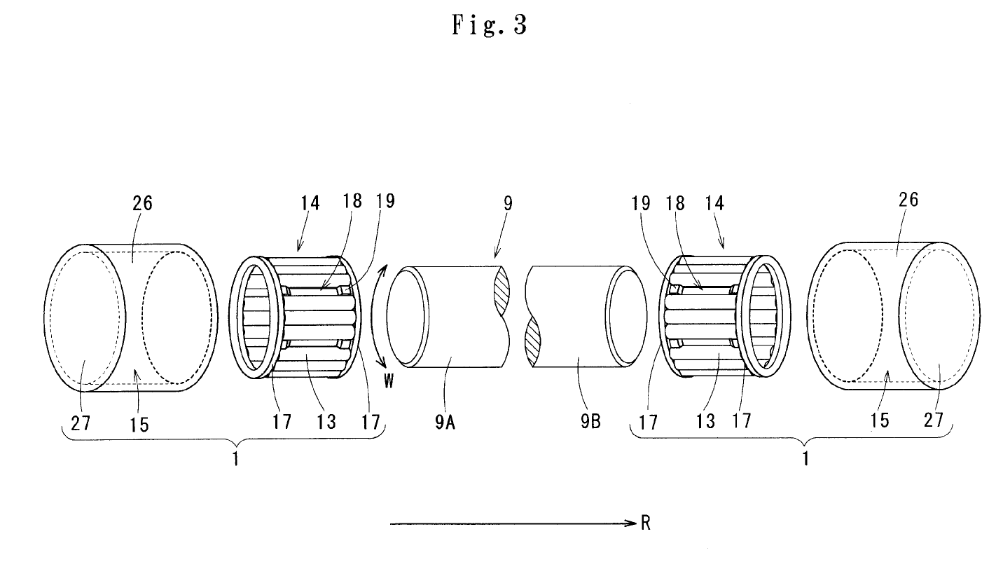

As shown in FIGS. 2 and 3, the pinion 3 has a plurality of pin rollers 9 made of metallic columns, and having support bodies 10A, 10B which support end portions of the pin rollers 9 in a manner that each of the pin rollers 9 has an axial direction R and placed in parallel each other along the axial direction R, and arranged in a cylindrical configuration.

The bearing device 1 is assembled within the support bodies 10A, 10B. The drive device 2 actuates the pinion 3 rotationally with the pin rollers 9 engaged with the rack 6 so as to advance the pinion 3 in the lengthwise direction M.

By way of illustration, each of the support bodies 10A, 10B is shaped in annular configuration. Each of the support bodies 10A, 10B has a circumferential direction Sx and having corresponding circular holes 11A, 11B in the circumferential direction Sx with regular intervals to accommodate the bearing device 1. The circular holes 11A, 11B are positioned in vicinity of an outer peripheral edge of the support bodies 10A, 10B.

The support bodies 10A, 10B are arranged so that the circular holes 11A, 11B face each other so as to assemble the pin rollers 9 to connectedly bridge between the support bodies 10A, 10B.

Namely, one end 9A of the pin roller 9 is rotatably supported via the bearing device 1 within the circular hole 11A, and the other end 9B of the pin roller 9 is rotatably supported via the bearing device 1 within the circular hole 11B.

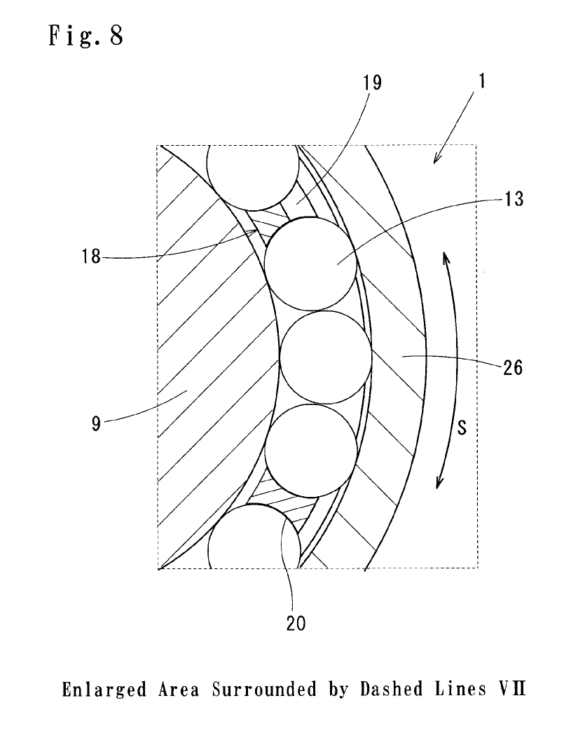

As shown in FIGS. 3 through 8, the bearing device 1 is accommodated within the circular holes 11A, 11B, and supports the one end 9A and the other end 9B of the pin roller 9 from outer peripheral sides thereof.

The bearing device 1 has a plurality of needle rollers 13, a cage 14 and a housing 15 as shown in FIG. 3. The cage 14 is made of synthetic resin by way of example.

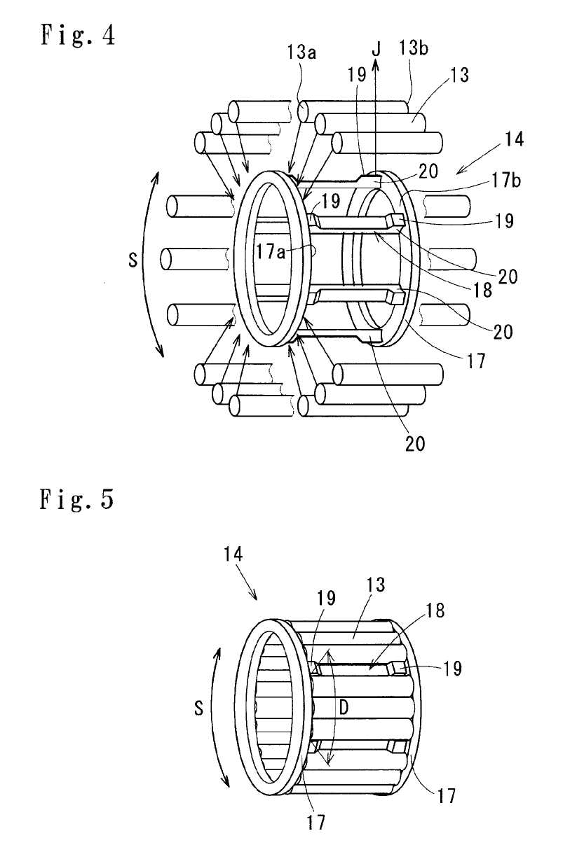

The needle rollers 13 are in the shape of metallic columns as shown in FIGS. 4 through 8.

The cage 14 arranges the needle rollers 13 to be axially placed in parallel each other along a circumferential direction W of the pin roller 9 in a cylindrical fashion.

Namely, provided is the cage 14 in which the needle rollers 13 are arranged in parallel with each other along the axial direction R of the pin rollers 9 (component objects), so that each of the needle rollers 13 forms a cylindrical configuration around the corresponding pin rollers 9.

Each of the pin rollers 9 is supported within an inner wall side of the cylindrical structure formed by the arranged needle rollers 13.

As shown in FIGS. 4 and 5, the cage 14 has oppositely placed two rings 17 and a plurality of bridge pieces 18 are provided to connectedly bridge between the two rings 17.

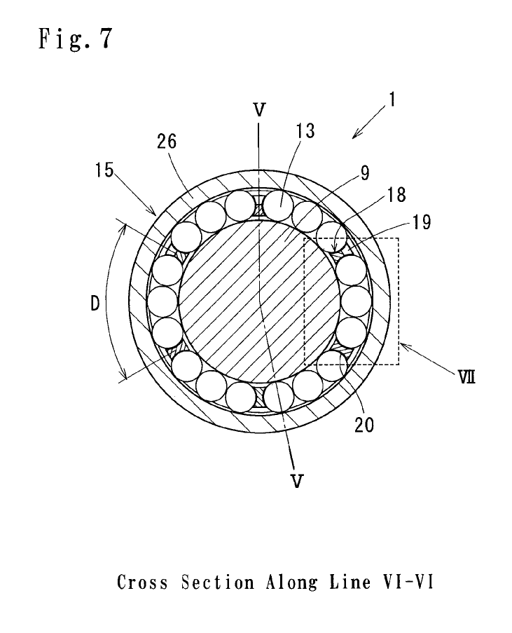

The bridge pieces 18 are distanced each other by a predetermined amount D in a circumferential direction S of the two rings 17 as shown in FIGS. 5 and 7.

Between the two bridge pieces 18, a plurality of needle rollers 13 are rotatably accommodated in contact with an outer surface of the pin roller 9.

In this instance, the needle roller 13 has one end surface 13a in contact with the inner surface 17a of one ring 17, and having the other end surface 13b in contact with the inner surface 17b of the other one ring 17.

It is favorable to determine the number of the needle rollers 13 to be two or three.

A thermal expansional coefficient of each of the needle rollers 13 is determined to be equal to a thermal expansional coefficient of each of the bridge pieces 18. These thermal expansional coefficients are determined in a linear direction.

With the equal thermal expansional coefficient determined between the needle rollers 13 and the bridge pieces 18, it is possible for the needle roller 13 (end surfaces 13a, 13b) to maintain a constant intensity of the contact against the inner surface 17a (17b) of the ring 17 irrespective of whether the ambient temperature changes in various ways.

Each of the bridge pieces 18 has both end ends outwardly bulged in a radial direction J of the pin rollers 9 to form bulged portions 19. Each of the bulged portions 19 has both sides in the circumferential direction so as to form cylindrical surfaces 20.

Each of the cylindrical surfaces 20 has a diametrical dimension identical to a diameter of one end portion of the needle roller 13. Each of the cylindrical surfaces 20 rotatably supports one end portion and the other end portion of the needle roller 13.

The needle roller 13 has one end surface 13a as a directed end in the axial direction R to be in contact with an inside surface 17a of the one ring 17, and having the other end surface 13b in contact with an inside surface 17b of the other ring 17,

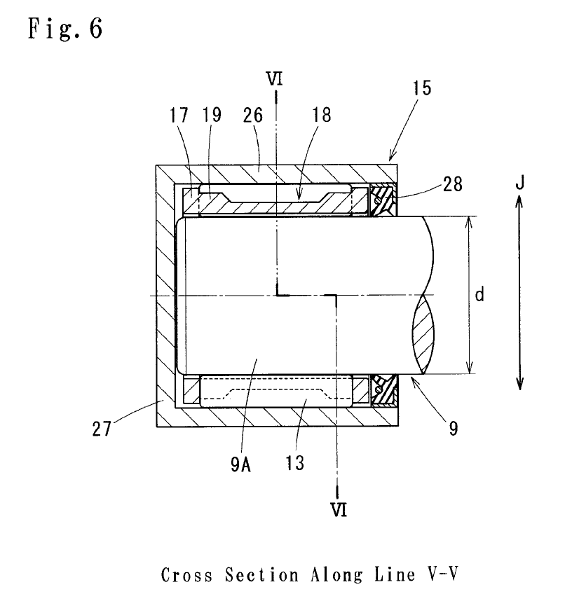

As shown in FIG. 6, the housing 15 which is made of metallic material has a cylindrical portion 26 and an occlusion plate 27. The occlusion plate 27 closes one open end of the cylindrical portion 26 so as to form a bottomed cylindrical body as a whole.

The housing 15 is firmly interfit into the circular holes 11A, 11B so as to rotatably accommodate the cage 14 into an inner wall side of the cylindrical portion 26. Each of the needle rollers 13 is rotatably in contact with the inner wall of the cylindrical portion 26, and also rotatably in contact with an outer surface of the pin roller 9.

At an inner surface in vicinity of the open end of the housing 15, an oil sealant 28 is provided.

With the structure thus far described, the bearing device 1 has the plural needle rollers 13 and the cage 14 which places the needle rollers 13 in the cylindrical configuration, and arranges the needle rollers 13 to respectively position in parallel with the axial direction of each of the needle rollers 13.

The pin roller 9 is rotationally supported by the cylindrical inner surface composed of the plural needle rollers 13. The cage 14 has two rings 17 which are placed oppositely to directly face each other.

Each of the plural bridge pieces 18 has the axial direction, and the plural bridge pieces 18 are fixedly placed between the two rings 17 along the axial direction R to bridge the two rings 17. Along the axial direction of the bridge pieces 18, the plural needle rollers 13 are axially placed to be accommodated between the bridge pieces 18 as shown in FIG. 7.

With the bearing device 1 structured as above, the bearing device 1 substantially corresponds to the “cageless roller bearing” and makes it possible to achieve the following performances.

Namely, it is possible for the bearing device 1 to withstand a greater amount of radial load with a small-scaled structure.

With the plural needle rollers 13 axially placed to be accommodated between the bridge pieces 18, it is possible to mitigate the needle rollers 13 from being inadvertently skewed against the pin roller 9. This makes it possible to obviate the necessity of providing the bridge pieces 18 at every space between neighboring ones of the needle rollers 13. This leads to solve the problems caused from the skewing phenomenon.

In accompany with the plural needle rollers 13 axially placed to be accommodated between the bridge pieces 18, it is possible to decrease an amount of friction between the needle rollers 13 to avoid an excessive temperature rise caused from the friction. This also reduces the amount of wear of the needle rollers 13, while at the same time, protecting the lubrication grease against an unacceptable deterioration.

With the minimum contact between the needle rollers 13, it is possible to decrease the amount of noise and vibration caused from the repetitive contact between the needle rollers 13.

With the minimum amount of the skewing phenomenon between the needle rollers 13, it is possible to mitigate the efficiency drop caused from the skewing phenomenon.

At each of the bridge pieces 18, both ends of the bridge piece 18 have the bulged portions 19 which bulge outward along the axial direction R of the pin roller 9 (bridge piece 18), it is possible to secure the grease-filling area at an axial space between the bulged portions 19 facing each other. The grease-filling area can be also secured on an outer surface of the bridge piece 18.

Each of the needle rollers 13 has one end surface 13a in contact with the inner surface 17a of one of the two rings 17, and having the other end surface 13b in contact with the inner surface 17b of the other of the two rings 17. This makes it possible to further mitigate the skewing phenomenon against the pin roller 9.

With the cage 14 made of the synthetic resin, it is possible to increase the freedom of design, compared to the case when forming the cage out of the metallic material.

By thinning each of the bridge pieces 18 as small as possible, it becomes possible to narrow the clearance between the needle rollers 13.

As opposed against the case in which the cage is made of the metallic material, it is possible to mitigate the friction between the cage 14 and the needle rollers 13 due to the contact therebetween. The mitigated friction makes it possible to reduce the deterioration of the lubrication grease.

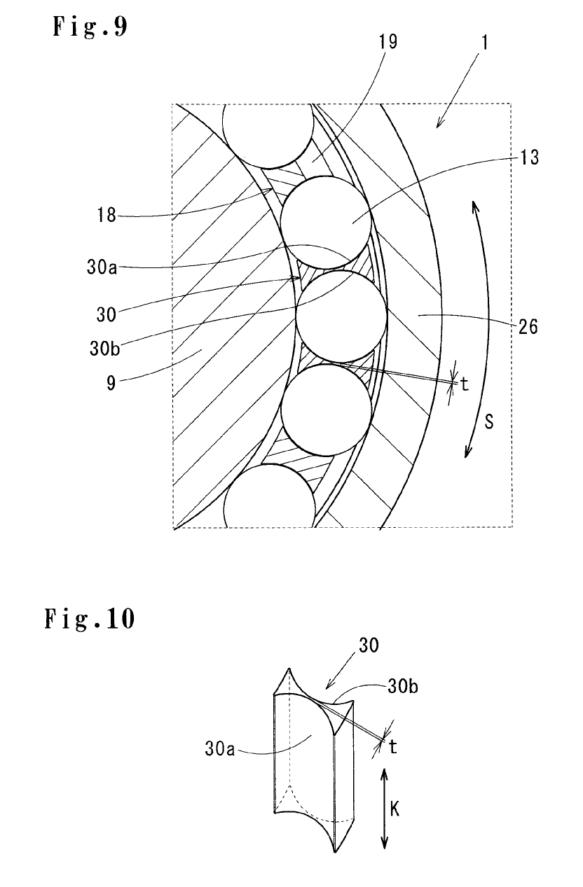

FIGS. 9 and 10 show a second embodiment of the invention in which a retainer 30 is made of synthetic resin, and interposed between the neighboring ones of the needle rollers 13 in the circumferential direction S.

The retainer 30 is shaped into a quadrangular column, and having cylindrically curved recesses 30a, 30b each facing in the opposite directions as shown in FIG. 9.

The retainer 30 has an axial direction K in parallel with the axial direction R of the pin roller 9, and the retainer 30 is assembled to the bearing device 1.

Each of the recesses 30a, 30b has a radius of curvature corresponding to a radius of the needle roller 13, so that inner surfaces of the recesses 30a, 30b come in contact with the corresponding needle roller 13.

As shown in FIG. 10, the minimum distance (t) between the two recesses 30a, 30b is determined to be from 0.1 mm to 0.5 mm inclusive.

Such is the structure that it is possible to obviate the needle rollers 13 from being directly in side-by-side contact with each other, thereby avoiding the friction-increasing situation in which the metallic needle rollers are directly in side-by-side contact with each other.

For this reason, it is possible for the bearing device 1 to withstand an increased amount of radial load so as to achieve a higher performance when rotating the pin roller 9 at higher speed.

It is to be noted that the synthetic resin applied to the retainer 30 may be the same material as applied to the cage 14. The synthetic resin may be an oil-impregnated resin. In this case, it is possible to obviate the necessity of the lubrication grease.

### Modification Forms

Instead of advancing the pinion 3 along the rack 6, it is possible to advance the rack 6 in accompany with the rotational movement of the pinion 3 when the pinion 3 is placed in a stationary position.

It is to be appreciated that the pinion 3 may be meshed with toothed wheels other than the rack 6, so as form different mechanisms other than the rack-and-pinion mechanism.

Instead of the bearing device 1 which supports the pin roller 9 of the pinion 3, the bearing device 1 may support any types of rotationally or reciprocally movable component parts other than the pin roller 9. Instead of the synthetic resin, the cage 14 may be made of metallic materials.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

What is claimed is:

1. In a bearing device which supports a component object which is rendered to be rotationally or reciprocally movable;
said bearing device comprising:
a plurality of columnar needle rollers,
a cage in which said needle rollers are arranged in parallel with each other along an axial direction of said component object, so that said needle rollers form a cylindrical configuration around said component object to support said component object at an inner surface of said cylindrical configuration formed by said needle rollers, and
said cage having oppositely placed two rings and a plurality of bridge pieces bridged between said two rings, and having said bridge pieces distanced each other by a predetermined amount in a circumferential direction of said two rings, and said cage rotatably accommodating said needle rollers in contact with an outer surface of said component object.

2. The bearing device according to claim 1, wherein each of said bridge pieces which is accommodated into said cage together with said needle rollers, has both end ends outwardly bulged in a radial direction of said component object to form bulged portions.

3. The bearing device according to claim 1, wherein each of said needle rollers has one end surface in contact with an inner surface of one of said rings, and having the other end surface in contact with an inner surface of the other of said rings.

4. The bearing device according to claims 1 and 2, wherein said cage is made of synthetic resin.

5. The bearing device according to claims 1 and 2, wherein a columnar retainer is interposed between neighboring ones of said needle rollers.

6. The bearing device according to claims 1 and 2, wherein said cage is made of oil-impregnated synthetic resin.

7. The bearing device according to claims 1 and 2, wherein a thermal expansional coefficient of each of said needle rollers is determined to be equal to a thermal expansional coefficient of each of said bridge pieces.
